(19) United States
(12) Patent Application Publication
(10) Pub. No.: US 2016/0331607 A1
(43) Pub. Date: Nov. 17, 2016

(54) ASSISTED SEATING SUPPORT

(71) Applicant: Cindy Whitted, Elmont, NY (US)

(72) Inventor: Cindy Whitted, Elmont, NY (US)

(21) Appl. No.: 14/709,751

(22) Filed: May 12, 2015

(51) Int. Cl. A61G 5/00; A47C 7/54; A61G 5/08; A47C 7/72; A47C 7/38

(52) U.S. Cl. CPC A61G 5/00; A47C 7/72; A47C 7/38; A61G 5/08; A47C 7/54

(57) ABSTRACT

An assisted seat device that includes: a vertical back support; a first head rest attached at the top of the vertical back support; a seat belt extending from the top of the vertical back support; arm rests extending from the vertical back support; a cup holder on each arm rest; and a seat attached at the bottom of the back support. The assisted seat device may further include an additional headrest below the first headrest, where first head rest pivots. The assisted seat device may also include a snap, where the snap supports the seat a folded position.

### BACKGROUND OF THE INVENTION

1. Field of Invention

The present invention relates to a device that is incorporated into a conventional seat to provide additional support for a user.

2. Description of Related Art

On many occasions an injured or disabled individual may have difficulty in maintaining a seated position in a conventional seat. This difficulty may arise both in a conventional chair or a vehicle seat. As a result, various types of devices have been developed to assist in maintaining an upright position in a conventional seat or a vehicle chair for the handicapped or injured. An injured or disabled individual may need additional back support and/or armrest while sitting in a conventional seat. Therefore any additional devices or aids that may be available would be beneficial for the injured or disabled.

### SUMMARY OF THE INVENTION

The present invention relates to an assisted seat device that includes: a vertical back support; a first head rest attached at the top of the vertical back support; a seat belt extending from the top of the vertical back support; arm rests extending from the vertical back support; a cup holder on each arm rest; and a seat attached at the bottom of the back support. The assisted seat device may further include an additional headrest below the first headrest, where first head rest pivots. The assisted seat device may also include a snap, where the snap supports the seat a folded position.

### BRIEF DESCRIPTION OF DRAWINGS

FIG. 1 depicts a perspective view of an assisted seating device in accordance with the present invention.

### DETAILED DESCRIPTION

The present invention relates to an assisted seating device that is used to assist in maintaining an upright seated position. The assisted seating device according to present invention is advantageously used by a disabled or injured individual to maintain an upright position while seated. The assisted seating device installs over a conventional seat and includes a back support along with an additional seated padding and a headrest. Further the assisted seating device includes a seatbelt or strap that helps to attach the device or maintain the device on the individual while using it. Further the present invention includes armrests that are used by the user in the seated position.

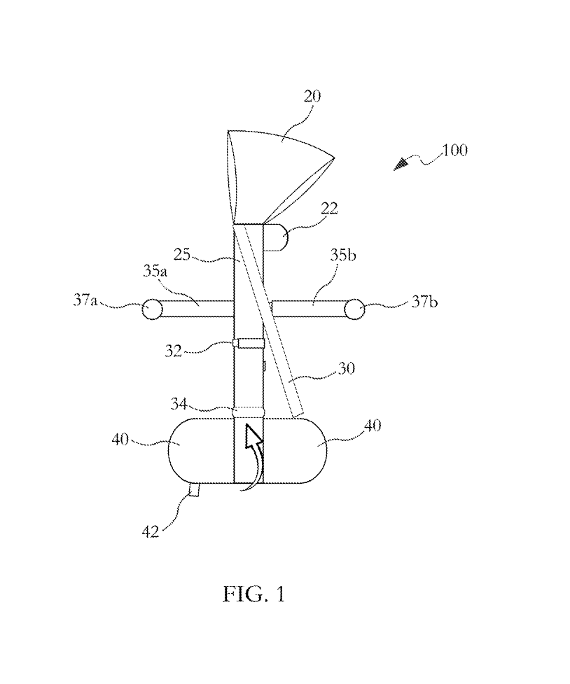

In reference to FIG. 1, a perspective view of assisted seating device 100 is depicted. The assisted seating device includes a vertical back support 25. At the top of the vertical back support is a headrest 20 that is coupled to the top portion of the back support 25. Further extending from the back support 25 is additional head and neck support 22. This additional head and neck support 22 remains stationary as opposed to the headrest 20, which may be pivoted into a suitable position for use. Further extending from the midpoint of the vertical back support 25 are armrests 35a, 35b. Each armrest 35a, 35b includes a cup holder 37a, 37b respectively on each armrest. Naturally the armrests 35a, 35b provide support for the user's arm when using the assisted seating device 100 is incorporated onto a conventional seat. A support clip 32 is provided along the back support 25 that clips the back support into a stabilized position onto the seat.

Other features of present invention include a seat 40 at the bottom of the back support 25. The seat 40 provides additional seat support for the user of the assisted seat device 100. Further a snap 11 is shown that is used to convert the seat into a folded position when not being used by the user. The assisted seat device 100 according to present invention may be incorporated into a conventional seat to assist the user in supporting himself or herself in an upright position due to inability or difficulty as a result of an injury or disability. The instant invention has been shown and described in what it considers to be the most practical and preferred embodiments. It is recognized, however, that departures may be made there from within the scope of the invention and that obvious modifications will occur to a person skilled in the art. The instant invention has been shown and described in what it considers to be the most practical and preferred embodiments. It is recognized, however, that departures may be made there from within the scope of the invention and that obvious modifications will occur to a person skilled in the art.

What is claimed is:

1. A assisted seat device comprising:
a. a vertical back support;
b. a first head rest attached at the top of the vertical back support;
c. a seat belt extending from the top of the vertical back support;
d. arm rests extending from the vertical back support;
e. a cup holder on each arm rest; and
f. a seat attached at the bottom of the back support.

2. The assisted seat device according to claim 1, further including an additional headrest below the first headrest.

3. The assisted seat device according to claim 2, where first head rest pivots.

4. The assisted seat device according to claim 1, further including a snap, where the snap supports the seat a folded position.
